(19) United States
(12) Patent Application Publication
(10) Pub. No.: US 2005/0191601 A1
(43) Pub. Date: Sep. 1, 2005

(54) Training weapon

(76) Inventor: Vojtech Dvorak, Jenks, OK (US)

Correspondence Address: Robert E. Massa, Ste 102, 1535 South Memorial, Tulsa, OK, 74112-7046, US

(21) Appl. No.: 10/787,690

(22) Filed: Feb. 26, 2004

(51) Int. Cl. G09B 19/00

(52) U.S. Cl. 434/16

(57) ABSTRACT

A training weapon which is quickly and easilyassembled from a standard weapon without requiring any physical modification (alteration) of any component of the standard weapon. A few components of the standard weapon are removed and replaced by components of the invention. This replacement does not exceed skill level beyond a standard field-strip procedure of the particular weapon. Action of the training weapon is of the same character as the action of the standard weapon, while developing trainee's responses to the substitute firing action, and at the same time improving trainee's skill, all without the use of live ammunition. Installed components include means of cycling the the weapon's mechanism thus simulating recoil using compressed gas, optional laser pointer activating a target, and a replacement magazine including source of electricity and an electronic control circuit and operable with a gas passage unit. Weapon's original trigger mechanism remains unchanged and is utilized to initiate the substitute firing cycle.

### FIELD OF THE INVENTION

My invention relates to a firearm training weapon. I have designed my firearm training weapon to be easily and efficiently prepared from a standard weapon by replacement of a few components of the standard firearm with a few components in a manner that the inherent characteristics of the standard firearm remain, such as: weight, size, recoil movement of a firing action, and sound of firing action. However, I have now easily provided a training weapon with measurement of performance electronically, without the use of live ammunition, while maintaining efficient proper training technique. I have accomplished this result while not permitting any physical modification of any component of an original standard weapon.

### BACKGROUND OF THE INVENTION

The ultimate goal in the use of weapons, is, and should be, marksmanship of the person firing the weapon. The user of a weapon should be proficient in firing the weapon. A marksman is a person skillful at hitting a target.

Proficiency in firing a weapon is acquired only when the trainee has become accustomed to the trigger characteristics and to the distracting effects of weapon fire, such as the recoil movement of the weapon and the loud sound of the shot.

Initially, a trainee anticipates the recoil movement and sound, and provides an unfamiliar or improper trigger pull which denies accuracy of his shot.

He must be trained to develop smooth, unanticipatory movement of the trigger, then his accuracy will improve. There are other factors which will be developed at the same time, including proper breath control.

These are abilities which are sometimes difficult to attain. And then, with standard weapons using live ammunition, the dangers to anyone around the firing range are extreme.

Many devices have been designed and developed to “simulate” the firing action of small weapons so that target practice and firearm handling may be safely carried on without the need to use live ammunition.

Most importantly, the basic concept of providing a training weapon has been to develop an instrument which will resemble a real weapon in most characteristics, and will be suitable to develop a trainee's adaptability to gain poise in handling a weapon, learning improved aiming of a weapon, becoming greatly accustomed to the noise and recoil conditions of a real weapon, all while gaining all this especially from the safe and economic use of a weapon only resembling a real weapon.

This is usually produced by operation of a valve member in coordination with a trigger member to give a sudden jolt of pressurized air. Other training devices are produced for simulating aiming practice by comprising complex attachments which would not adequately direct a trainee's attention to an action of a real weapon, but would prevent his acceptance of the simulated weapon as a practical training device.

The training weapons available today cover a wide range of construction and appearance. I have found that some of the training devices often are not real weapons, but replicas that provide limited realism. Even though they simulate many aspects of firing, their triggers are apart from the original and have different characteristics. Weight, balance and cycling action of these devices are also noticeably different from the real weapons. Other training devices are produced by alternation of real weapons and their appearance and function are quite realistic. The shortcoming of these devices often are that they comprise of complex attachments which distract a trainee's attention to the weapon, and prevent his acceptance of the product as a practical training device. In effort to make a functional training weapon from a real weapon, this original weapon often needs to undergo a special modification to an extent, which is beyond the capability of an ordinary trainee. Such modification is often irreversible, yielding this weapon useless for firing live ammo ever in the future.

In my experience, I should like to identify various training apparatus in the following categories:
1. Simulated weapons providing laser measurement or display of marksmanship. These are devices which are not weapons, but electronic devices to display or mark an exemplary target shot, offering only very limited realism.
2. Weapons firing cartridges of reduced energy, or blank cartridges.
3. Weapons firing cartridges filled with compressed air.

The costs of cartridges in categories 2 and 3 are not too far removed from the cost of live ammunition. While they offer a relatively safe means of training, their monetary savings is minimal.
4. Weapons using compressed gas or pneumatic pressure to simulate recoil, not using cartridges.
   Weapons in this category can be more cost effective because of the lower cost of compressed gas or air. However, as I have seen, these designs suffer from a number of disadvantages. They are quite extensively modified, use bulky external attachments and occasionally, require mechanical installation beyond the capability of the average trainee, or they are not real weapons, but replicas with limited realism.

My device also uses pneumatic means for simulating recoil but overcomes the weaknesses of the above category. I cite below prior art, which I have discovered from the closest relations to my weapon.

My long experience in the field of electronics has enabled me to become aware of and thoroughly understand, the development of patented devices and systems described in the following U.S. Patents:

| | | |
|---|---|---|
| U.S. Pat. No. 4,302,190 | Shaw et al | Nov. 24, 1981 |
| U.S. Pat. No. 4,380,437 | Yarborough, Jr. | Apr. 19, 1983 |
| U.S. Pat. No. 4,480,999 | Witherell et al | Nov. 6, 1984 |
| U.S. Pat. No. 5,857,854 | Kwalwasser | Jan. 12, 1999 |
| U.S. Pat. No. 5,947,738 | Muehle et al | Sep. 7, 1999 |
| U.S. Pat. No. 6,146,141 | Schumann | Nov. 14, 2000 |

Shaw, U.S. Pat. No. 4,302,190, describes the manner in which a real rifle has been drastically modified to provide an apparatus which simulates only the recoil motion of a real weapon without cycling the mechanism. The rifle has been re-structured to direct a stream of compressed air thru the stock of the rifle then thru the barrel. Electronic timing means is actuable by movement of the trigger and actuates an external solenoid valve system controlling the flow of compressed air.

Yarborough, Jr., U.S. Pat. No. 4,380,437, describes a replica of a gun body which is designed to support and contain functioning and control modules to include a laser transmitter, recoil means, sound means, and means to develop a lifting force on the forward portion of the gun body when the trigger is actuated.

Witherell et al, U.S. Pat. No. 4,480,999, describes a firearm which has been modified to include and support the controls and tubing for a source of pressurized gas attached to the trigger, frame, and barrel in a manner to cooperate with the trigger mechanism to provide a recoil movement.

Kwalwasser, U.S. Pat. No. 5,857,854, describes a weapon simulator in which the rifle barrel is modified to provide the recoil effect in cooperation with a piston rod and cylinder constructed therein to provide recoil effect in accordance with the flow of compressed air.

Muehle et al, U.S. Pat. No. 5,947,738, describes a simulated weapon in which a pressure switch is secured inside the weapon's barrel and reacts to pressure changes caused by activation of an air cartridge.

Schumann, U.S. Pat. No. 6,146,141, describes a replica of a pistol constructed to contain a laser device mounted in the barrel, and a compressed air cylinder also mounted in the barrel, with both operable by movement of the trigger.

### SUMMARY OF THE INVENTION

The primary object of my invention is to provide a training weapon which is simple, easy to use, and safe.

Another object of my invention is to provide a training weapon which is adaptable from an original weapon without physical alteration of any component of the original weapon.

Another object of my invention is to provide a training weapon by modification of an original weapon without physical alteration of any extant component of the original weapon.

Another object of my invention is to provide a training weapon which is adaptable from an original weapon by replacing components of original weapon with training components to provide a safe training weapon.

Another object of my invention is to provide a training weapon by substituting components of the original weapon in a manner to provide a safe training weapon having no distracting training components.

Another object of my invention is to provide a training weapon which is adaptable from an original weapon in establishing beneficial traning actions in a safe manner.

Another object of my invention is to provide a training weapon which is easily and quickly adaptable from an original weapon without any physical alteration of the original weapon and which is quickly convertible to the original weapon.

### DESCRIPTION OF THE DRAWINGS

FIG. 1 is a schematic side view of a training weapon according to my invention showing actuable components of the invention in operating position in a pistol.

FIG. 2 is an exploded view of a training weapon according to my invention showing actuable components of the invention.

FIG. 3 is a side view of an alternate embodiment of a training weapon according to my invention showing actuable components in operating position in a rifle.

FIG. 4 is a side view in cross section of barrel and recoil valve components of a training weapon according to my invention.

FIG. 5 is a side view in cross section of electrical and pressure components according to my invention in alternate position from components described in FIG. 1.

### DETAILED DESCRIPTION OF THE PREFERRED EMBODIMENTS

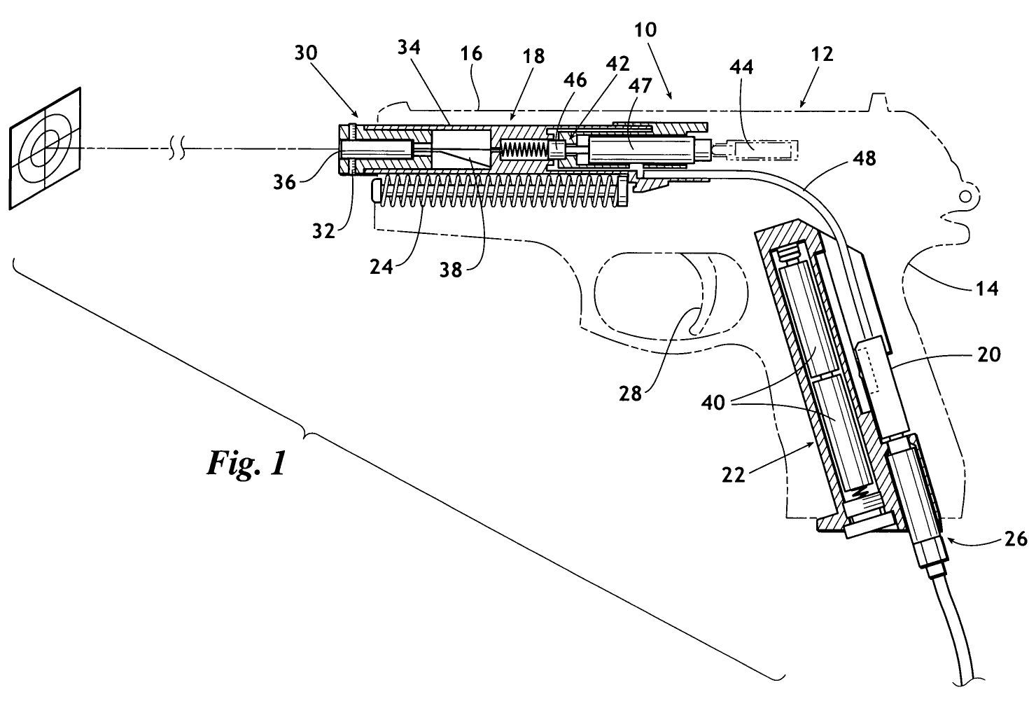

In FIG. 1 I show a view, partly schematic and partly in cross section, of a training weapon as I have constructed as part of my invention.

In schematic condition I show a training weapon 10, generally, as it would be adaptable from a standard weapon, as in this figure, a standard pistol 12, generally, such as a Glock or a Beretta.

As I had emphasized above, I had removed a few of the actual standard components of the standard weapon and I had replaced them by components of the training assemblage which were easily placed into the operating position in the standard weapon frame and latched into place. When the training weapon is ready to operate, it should practically duplicate in appearance the original standard weapon except for a length of tubing from a pressure cylinder or tank.

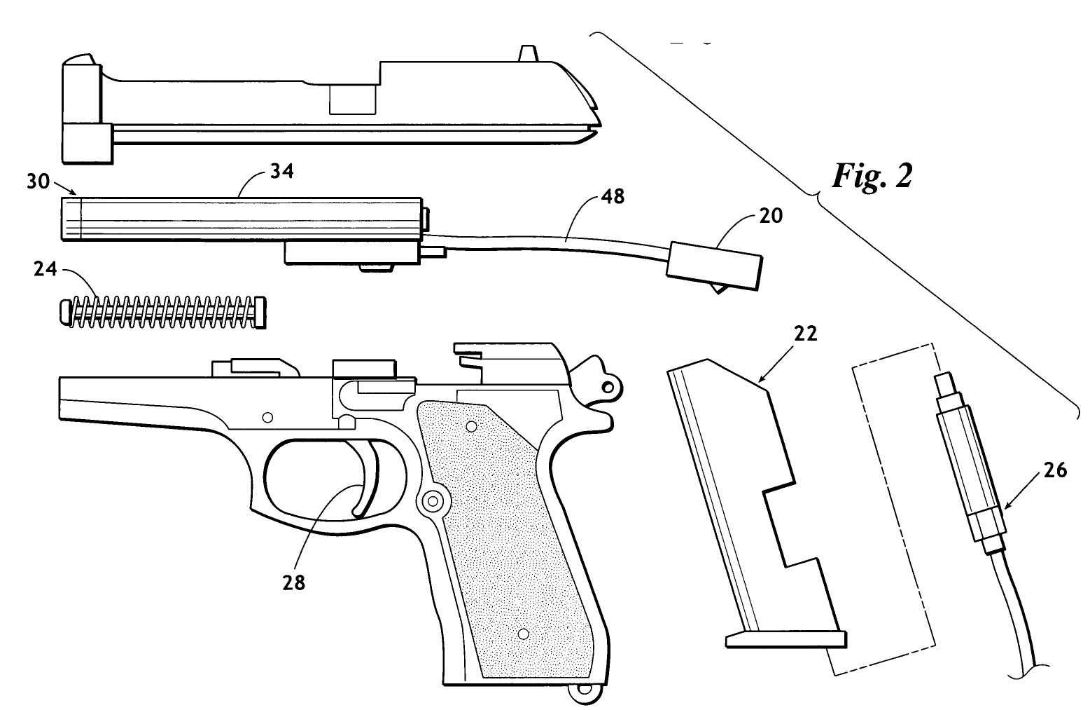

In the exploded view of FIG. 2, I describe the main components of my training weapon as they would be in proper arrangement ready to be combined with a frame member 14, generally, and a slide 16. The main components of the conversion system as shown unattached in FIG. 2, and in position in FIG. 1, comprise barrel and valve actuator component 18, generally, and an interface block member 20 attached thereto, magazine 22, generally, recoil spring 24, and gas coupling member 26, generally. The interface block member 20 includes connecting components to provide a simple means for easily connecting a gas line and to make quick electrical connections.

Operating components of the original weapon which are not removed include a trigger 28 which is still in operating connection to a hammer (not shown).

A laser component 30, generally, is securable at one end of barrel component 18, and includes a set of adjustment screws 32 for adjusting the angle of the laser for accuracy.

As I stated, I have designed and and invented my training weapon so that components and manner of operation will essentially appear to provide a weapon which will have an appearance closely resembling an original weapon from which the training weapon was converted, such characteristics as weight, size, and above all, trigger and recoil operation, with sound and firing control, such as shot counter and weapon operation after a last shot, slide or bolt latch, with the various mechanical operations adjustable by the electronics of the weapon.

In FIG. 2, I show the outer appearance of the various components and their relative positions, but, in FIG. 1, I describe the more distinct details of the operating components.

Actuator component 18, generally, comprises a replaceable barrel member 34, for a pistol, which is latched into place on a pistol frame 14, generally, in the same manner as an original pistol barrel had been. Barrel 34 includes laser component 30, generally, includes an emitter (not shown), having connecting wires 38 connecting the laser to an electric source, such as a battery 40 held in magazine 22, generally.

Actuator component 18 also includes a valve 42, generally, which controls the flow of pressurized gas upon the operation of the trigger 28, and a piston component 47 which pushes slide 12 of the pistol during firing cycle.

Operation of trigger 28, which is connected to a hammer (not shown) causes the hammer to operate a striker 44 which through piston 47 urges a valve member 46 into an open position permitting pressurized gas to enter the space in front of piston 47 thru line 48 and the small space provided around barrel and valve member 18 and valve 42 to provide a recoil operation. Valve member 46 also acts as an electrical switch to energize laser 36 via connecting wires 38. After the expenditure of the gas at the end of a stroke, the recoil spring 24 moves the slide 12 of the pistol back into closed position.

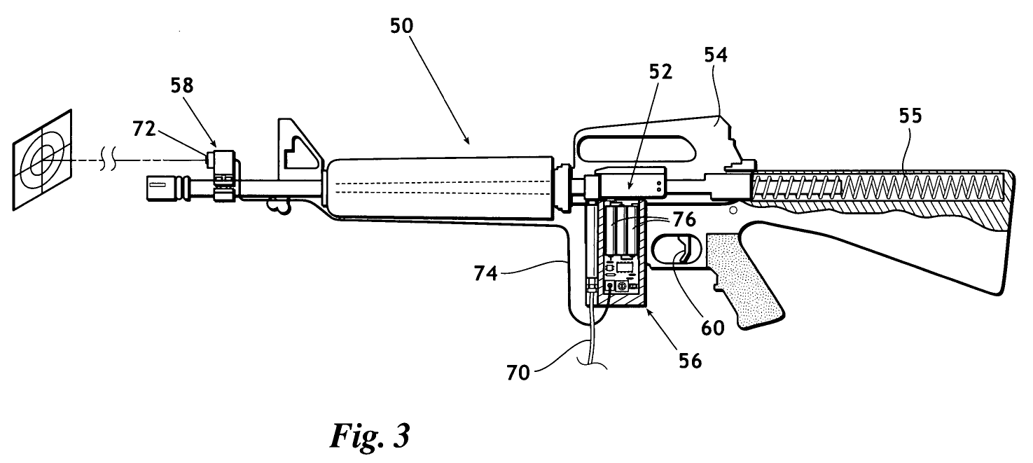

In my schematic view of FIG. 3, I describe an alternate embodiment of my training weapon as it would appear in position on a rifle 50, generally. In the training rifle assemblage according to my invention, I do not have to replace the entire barrel of a standard weapon. I found it much more convenient to leave the original barrel in place and assemble actuator components in a portion of the original bolt carrier.

The mode of operation still involves the same general components as with a pistol, that is, I maintain an original rifle frame and place thereon in a manner to give a training rifle the same appearance as a standard weapon, and place an actuator component 52, generally, in position on a rifle upper receiver 54, a magazine 56, generally, and laser component 58, generally. Actuator 52 has a stationary part 63 and a moving part 65.

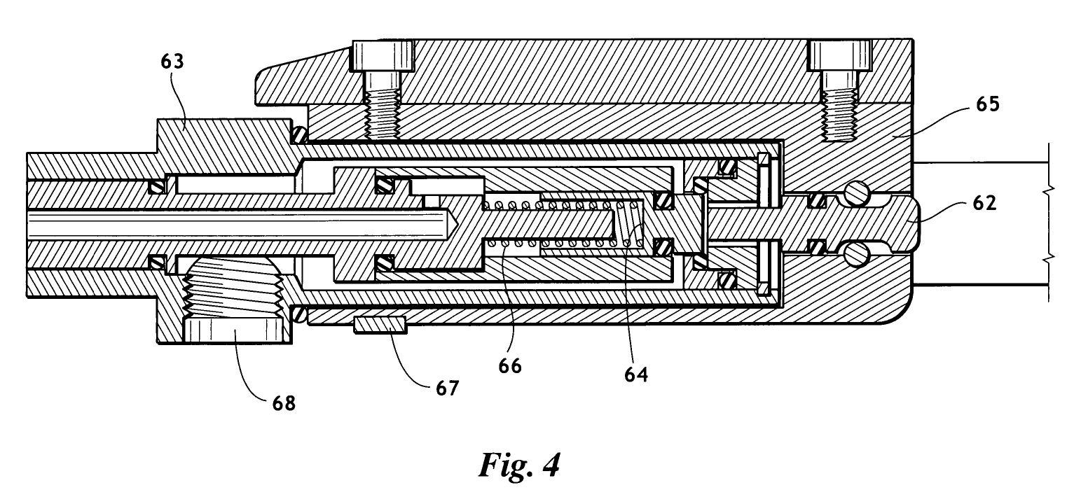

Action of the trigger 60 operates a hammer (not shown) which moves against a striker 62, as shown in FIG. 4, to operate valve 64, generally, with opening of valve 64 compressing valve spring 66 and providing opening between valve 64 and gas inlet 68, which is connected to gas line 70. Compressed gas flowing through valve 64 pushes actuator part 65 away, thus simulating recoil. Movement of part 65 through its actuator 67 actuates switch 75 providing a signal to energize laser 58 which has an emitter 72 therein, connected to a source of electricity, such as battery 76 and an electronic circuit 78 with mode selector 80 positioned in magazine 56. Laser module can alternatively be placed inside the gun's barrel as an extension of stationary component 63 and triggered by valve component 64 as in the earlier described pistol embodiment. When moving part 65 disengages stationary part 63, the rapid expenditure of gas produces an audible effect and causes valve 64 to shut off. Subsequently, spring 55 returns part 65 to closed position and cycle is complete.

In my training rifle 50, generally, I have noticed several distinct positions which are most favorable for certain types of rifles, and which, for instance, are most suitable to a positioning of a laser emitter at a different position, depending upon the structure of the original weapon. For example, positioning a laser component inside the barrel, or upon the barrel. Or, even, for example, a different structure for a magazine component, but in all structures, having all operating components of the same character. My magazine can be made with a built-in cavity or reservoir member containing compressed gas, thus eliminating the need for an air hose and providing a completely tether-less solution.

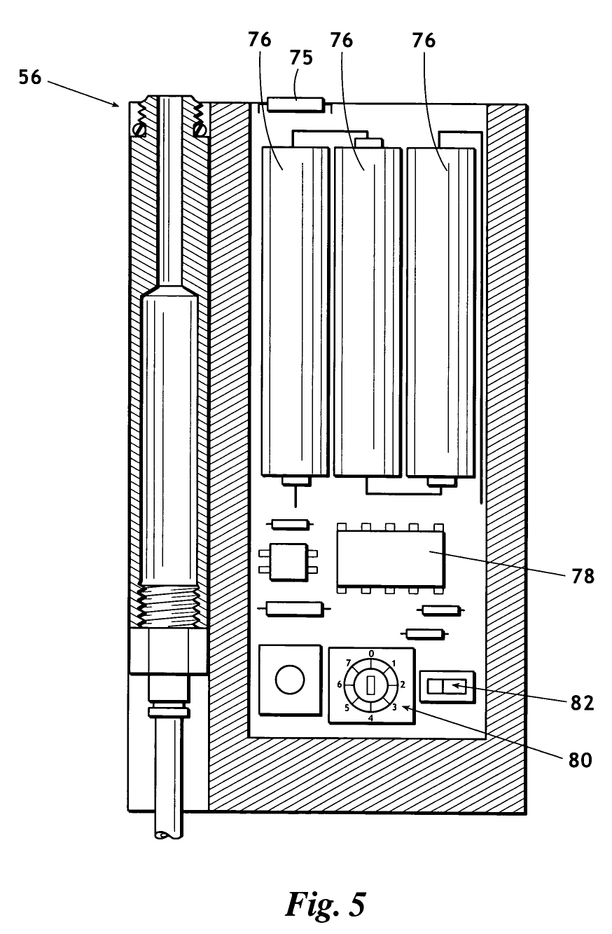

The electronic components which operate for all my training weapons include the components shown most clearly in FIG. 5. After placing the electronics components in careful position, the electronics components are made operable by a slight tightening of the bolt which secures the battery channel as shown in FIG. 1, or by a slide switch 82 in FIG. 5. The electronic circuits are placed in the magazine under suitable safety cover in a manner that only a mode selector need be available for adjustment, and an LED indicator is visible to the user.

I have designed this circuitry with a programmable microprocessor so that the modified weapon will provide a weapon response with each shot ostensibly identical with the response of the original weapon, but will also provide a laser response which may be adaptable for a variety of training missions. The chosen effects would be a measure of the trainee's skill.

I have designed mode selector 80 to be able to perform a variety of control actions, such as: to be able to act as a shot counter, to alter the laser pulses thru a variety of pulses, or to activate slide or bolt catch mechanism after a predetermined number of rounds are fired.

I have shown my training weapon in several embodiments and have stated that various components may be easily adjusted to achieve certain conditions applicable to the standard type of weapon which is being adapted, such minor arrangements as choosing different pulse actions, choosing pressure build up as required by different weapons, or using a variety of pressurized gas which might be most suitable for a particular weapon, or training condition, wherein compressed air might be chosen as a particular gas found most favorable.

Therefore, since many different embodiments of my invention may be made without departing from the spirit and scope thereof, it is to be understood that the specific embodiments described in detail herein are not to be taken in a limiting sense, since the scope of the invention is best defined by the appended claims.

1-10. (canceled)

11. A training weapon adaptable from an original weapon without physical modification of original weapon, said training weapon comprising:
a frame of said original weapon,
a barrel,
a gas passage component mountable in said barrel, comprising:
a piston and rod component, including a recoil. spring member, and
a control valve component in operable connection with piston and rod component, providing openable and sealable means for passage of gas, wherein passage of gas provides a recoil condition to weapon,
a trigger component in operable connection with a hammer component with said hammer component in operable position with said piston and rod component,
a magazine component positionable upon said frame, having:
means for providing a source of electricity, means for connecting a source of pressurized gas to said control valve component,
an electronic control component connectible to said source of electricity, and
a mode selector in operable connection to said electronic control component to perform a variety of control actions, and
a transmitter mountable upon said frame for transmitting an energy beam in a direction parallel to axis of said barrel,
said transmitter adjustably connectible to said source of electricity and to said electronic control component, wherein operation of said trigger component actuates a firing cycle of said weapon.

12. A training weapon as described in claim 11, wherein:
said control valve component provides an open condition for passage of pressurized gas at a beginning of a cycle, and a recoil spring member provides a recoil of weapon at end of said cycle.

13. A training weapon as described in claim 12, wherein:
said transmitter comprises a laser component.

14. A training weapon as described in claim 13, wherein:
said mode selector is operable to provide an actuating signal to said laser.

15. A training weapon as described in claim 14, wherein:
said mode selector is operable to provide a signal to said laser for altering a laser pulse.

16. A training weapon as described in claim 15, wherein:
said mode selector is operable as a shot counter.

17. A training weapon as described in claim 16, wherein:
said mode selector is operable to operate a slide or bolt catch component.

18. A training weapon as described in claim 17, wherein:
said mode selector is operable to operate a slide or bolt catch component after a predetermined number of shots.

19. A training weapon as described in claim 18, wherein:
said source of electricity is a battery.

20. A training weapon as described in claim 19, wherein:
said pressurized gas is compressed air.

21. A training weapon as described in claim 20, wherein:
said training weapon is adaptable from an original pistol.

22. A training weapon as described in claim 20, wherein:
said training is adaptable from an original rifle.

23. A training weapon as described in claim 11, wherein:
said training weapon is a pistol.

24. A training weapon as described in claim 11, wherein:
said training weapon is a rifle.
